(19) United States
(12) Patent Application Publication
(10) Pub. No.: US 2013/0338843 A1
(43) Pub. Date: Dec. 19, 2013

(54) SYSTEMS, METHODS AND CONTROLLERS FOR CONTROL OF POWER DISTRIBUTION DEVICES AND SYSTEMS

(71) Applicants: Reza Iravani, Toronto (CA); Mohammad Sedighy, Oakville (CA); Tom Wai Lai Ma, Toronto (CA)

(72) Inventors: Reza Iravani, Toronto (CA); Mohammad Sedighy, Oakville (CA); Tom Wai Lai Ma, Toronto (CA)

(21) Appl. No.: 13/692,819

(22) Filed: Dec. 3, 2012

Related U.S. Application Data
(60) Provisional application No. 61/660,915, filed on Jun. 18, 2012.

(51) Int. Cl. H02J 4/00

(52) U.S. Cl. CPC H02J 4/00
USPC 700/295

(57) ABSTRACT

Various distribution side controllers for power systems are disclosed. Power systems includes a power generation subsystem and one or more distribution networks. Power systems may also include a transmission system coupled between the power generation subsystem and the distribution networks. The distribution side controller monitors the operation and availability of power from distributed power sources coupled to its respective distribution network, as well as load demand from loads on the distribution network. The distribution side controller may also monitor conditions on the distribution network to identify a power imbalance within the distribution network. The distribution side controller responds to such imbalances to reduce their effect on the power system as a whole. In some embodiments, multiple distribution side controllers for various distribution networks may cooperate to provide efficient power generation for the whole power systems. In some embodiments, an AGC that controls the power generation subsystem also operates in coordination with one or more distribution side controllers.

### FIELD

The described embodiments relate to control of load, power source or power storage elements coupled to an electric power distribution network.

### BACKGROUND

Large electric power systems typically include three broad subsystems: a power generation subsystem, one or more transmission network and one or more distribution networks. Power is primarily generated in the power generation subsystem, which is typically distributed geographically with a variety of power sources located conveniently for their respective sources of energy and for other reason. The various power sources are coupled to the transmission network at various points. The generated power is transmitted from the power generation subsystem to distribution networks through the transmission network. The various distribution networks include a variety of loads that are powered by the transmitted power. Modern distribution networks typically also included various types of power sources for private use by a particular entity to power that entity's own loads or to generate power that is then fed-in to the power system and made available to power loads owned by other entities, or for both private power use and for feed-in power.

During operation of a power system, an automatic generation controller (AGC) is typically used to monitor one or more conditions of the power system, such as the system frequency of the power supply. The AGC is coupled to some or all of the power sources in the power generation subsystem to control their operation in order to maintain some or all of the monitored conditions within a desired range. For example, an AGC may monitor the system frequency of a power system with the objective of maintaining the power supply within a range of 59.95 Hz to 60.05 Hz. It is desirable to maintain a balance between power supply and load on the power system. When power supply exceeds load, the system frequency will typically rise and vice versa. The AGC monitors the system frequency and increases or decreases power production by power sources under its control to maintain the system frequency in the desired range.

The AGC is responsive to changes in availability of power from particular power sources and to changes in the total load that have a noticeable effect on the system frequency. In the response, the AGC controls the production of power by dispatchable power sources such that the system frequency remains within the desired range.

Some power sources, including some renewable power sources such as wind power sources and solar power sources are dependent on the availability of environmental conditions, such as wind and solar energy to generate power. Depending on environmental conditions, the power generation by these power sources may be limited and may be highly and unpredictably variable. For example, a wind gust, a decrease in wind speed, movement of clouds and other weather events may cause a rapid change in the availability of power from such power sources, rendering them less predictable in terms of consistently generating power at a desired level. In this document, renewable power sources will be referred to as an example of such less consistent or intermittent power sources. However, it should be understood that such references apply equally to other power sources that may provide limited or no power as a result of environmental or other conditions beyond the control of a power system or power source operator.

Renewable power sources are increasingly deployed in power generation subsystems of many power systems. Changes in the power output from these power sources can create an imbalance between power supply and total load. Similarly, changes in the load on the power system can also create such an impalance.

In modern power systems, there is increasing penetration of renewable power sources, such as wind power sources and solar power sources which are not dispatchable or are at least subject to the availability of environmental factors such as wind or light. These power sources may be highly intermittent and power availability from them may be high unpredictable, particularly when weather or other relevant conditions change.

### SUMMARY

Some embodiments described herein provide a distribution side controller for a power system. The power system includes a power generation subsystem and a distribution network. A transmission network may be interposed between the generation subsystem and the distribution network to transmit electric power generated in power generation subsystem to the distribution network. The distribution network includes various distribution side devices including one or more distributed power sources, typically including one or more renewable or other efficient or preferable power sources, various loads and may optionally include one or more power storage elements. The distribution side controller is coupled to some or all of the distribution side devices to control the operation of the devices and to obtain information about their operation. With respect to distributed power sources, the distribution side controller may be able to dispatch power generation within the operation limits of the respective sources, which may be limited by environmental factors. The distribution side controller may also be able to obtain information about the operation and operating range of the power sources. The loads may include one or more controllable loads that can be used to reduce or increase power demand from the distribution network.

In operation, the distribution side controller typically operates in a steady operation state in which it monitors the distribution network to identify a power imbalance or other undesirable trigger condition on the distribution network. In response to such trigger conditions, the distribution side controller enters a recovery operating state, in which it reacts rapidly to restore a power balance or otherwise eliminate the undesirable condition. The distribution side controller may do so by increasing or decreasing power generation from distributed power sources, by increasing or decreasing load on the distribution network or by a combination of methods.

After this initial response, in some embodiments, as required in some instances, the distribution side controller may enter a preferred operation mode, in which the distribution side controller may act to change the operation of distribution side devices to achieve a more efficient or otherwise preferred or desirable operating point. For example, the initial rapid response may result in a power balance but also result in power being produced by costly or inefficient power sources. Power production may be shifted to more efficient or cost effective power sources. Power production and load demand may be varied to reduce the total power generation in the system or other changes may be made depending on the objectives to be achieved by the distribution side controller. Once an efficient or desirable power balance and operation has been achieved, the distribution side controller continues to monitor the distribution network to identify another power imbalance or other disturbance scenario.

By reducing the length and magnitude of power imbalances in the distribution network, the operation of the distribution side controller can reduce power imbalances in the power system as a whole and can reduce the need for spinning reserves and other measures typically used to address changes in demand.

In some embodiments, a plurality of distribution networks may receive power from a common power generation subsystem, which may itself be widely geographically distributed and may be coupled to a transmission network at various places to inject power into the transmission network or power grid. Some or all of the distribution networks may have distribution side controllers that are coupled to one another to achieve efficiency. The coupled distribution side controllers may operate as peers or under the control of a master distribution side controller or a separate master controller to achieve efficiencies between the respective distribution networks. For example, power demand in one distribution network may be efficiently supplied by increasing feed-in power production in another distribution network. Such arrangement may be identified and implemented by the distribution side controllers, reducing the need for increased power production in the power generation subsystem.

In some embodiments, the distribution side controller may be coupled to an automatic generation controller that controls power generation in the power generation subsystem. The distribution side controller or controllers may cooperate with the automatic generation controller to increase the use of renewable and other preferred power sources, both in the power generation system and in the distribution networks.

In some embodiments, the distribution side controllers may be coupled to external data sources that provide environmental information that may affect power production from renewable power sources, pricing information about the availability of power from other power systems or sources, demand forecasts and other information. The distribution side controllers may take this information into account in determining the mix of power sources, including sources in the power generation subsystem, distribution power sources that provide feed-in power and external power sources that should be used to meet demand in the power system and in individual distribution networks.

In some embodiments, a distribution network may include a plurality of distribution side devices or components that operate together. For example, a distribution network may include distribution side devices at a factory, building, metal processing or other manufacturing or commercial installation or facility. In such situations, a distribution side controller may be coupled to distribution side elements at the facility to monitor the distribution network at the facility and to receive data from and to control the operation of distribution side devices at the facility.

In another aspect, some embodiments provide a method of operating a power system having a power generation subsystem and a distribution network coupled to the power generation subsystem, wherein power generation subsystem provides a distribution power supply to the distribution network and the distribution network includes one or more distributed power sources that supply a feed-in power supply, the distribution power supply and the feed-in power supply collectively providing a total distribution network power supply, the method including: monitoring one or more characteristics of the total distribution network power supply; controlling the operation of one or more of distribution side devices in response to the monitored characteristics.

In some embodiments, the method further includes: identifying an imbalance between total distribution network load exceeds total distribution network power supply; changing the total distribution network power supply to balance the total distribution network load and the total distribution network power supply; and rebalancing the distribution power supply and the feed-in power supply to increase usage of renewable or other preferred power sources.

In some embodiments, the method further includes: identifying a condition in which total distribution network load exceeds total distribution network power supply; and in response to the reduction in feed-in power supply, increasing the distribution power supply.

In some embodiments, the method further includes: identifying a reduction in the feed-in power supply; and in response to the reduction in feed-in power supply, increasing the distribution power supply.

In some embodiments, the method further includes: identifying a condition in which total distribution network load exceeds total distribution network power supply; and in response to the reduction in feed-in power supply, increasing the distribution power supply.

In some embodiments, the method further includes: balancing the distribution power supply and the feed-in power supply to increase the usage of renewable power sources.

Some embodiments provide a method of controlling one or more distribution side devices coupled to a distribution network, the method including: identifying a trigger condition; and in response to the trigger condition, restoring a power balance between distribution network power and distribution network load.

In various embodiments, the power balance may be restored by a method selected based on the trigger condition, by a method selected based on an imbalance that causes the trigger condition, by increasing distribution network power, by dispatching greater feed-in power to the distribution network, by dispatching greater power production from a distributed power source, by decreasing distribution network load, by decreasing distribution network power, by dispatching less feed-in power to the distribution network, by dispatching less power production from a distributed power source, by increasing distribution network load or by taking a combination of these actions.

In some embodiments, the distribution side devices include one or more controllable loads and wherein the power balance is restored by controlling one or more controllable loads to increase power draw from the distribution network.

In some embodiments, the distribution side devices include one or more controllable loads and wherein the power balance is restored by controlling one or more controllable loads to increase power draw from the distribution network.

In various embodiments, a trigger condition may relate to one or more monitored conditions reaching a state outside a corresponding defined range, a power imbalance in one or more monitored conditions, a change in feed-in power supply to the distribution network, a change in distribution power supply to the distribution network, a change in distribution power supply to the distribution network or a combination of these conditions.

In some embodiments, the trigger condition is identified by monitoring one or more conditions in the distribution network.

In some embodiments, the distribution network is coupled to a transmission network and the trigger condition is identified by monitoring one or more conditions in the transmission network.

In some embodiments, the method includes modifying the operation of distribution side devices to a preferred operation mode.

In some embodiments, the preferred operation mode maintains a power balance between distribution network power and distribution network load.

In some embodiments, the preferred operation mode achieves a preferred operation objective selected from the group consisting of: increasing usage of renewable energy sources; increasing feed-in power in the distribution network; increasing power production by cost effective power sources; increasing power production by energy efficient power sources; decreasing power consumption in the distribution network; and decreasing power consumption in a power network coupled to the distribution network.

Some embodiments provide a method of operating a distribution side controller for a power network including a distribution network, wherein the distribution network includes a plurality of distribution side devices, the method including: activating the distribution side controller in a steady operating state in which the distribution side controller monitors the power network to detect a trigger condition, wherein the trigger condition corresponds to a power imbalance in the power system; upon detecting a trigger condition, switching the distribution side controller to a recovery operating state in which the controller modifies the operation of one or more devices coupled to the power network to restore a power balance.

In some embodiments, the distribution controller is coupled to the distribution network and wherein, in the steady operating state, the distribution side controller monitors the distribution network to detect the power imbalance within the distribution network.

In some embodiments, the method includes, after restoring the power balance, returning to the steady operating state.

In some embodiments, the method includes, after restoring the power balance, switching the distribution side controller to a preferred operation mode in which the distribution side controller modifies the operation of one or more devices coupled to the power system to achieve a preferred operation objective.

In some embodiments, the method includes, after restoring the power balance, switching the distribution side controller to a preferred operation mode in which the distribution side controller modifies the operation of one or more distribution side devices to achieve a preferred operation objective.

In some embodiments, the method includes, after achieving the preferred operation objective, returning to the steady operating state.

Some embodiments provide a method of operating a distribution side controller for a distribution network including a plurality of distribution side devices, the method including: activating the distribution side controller in a steady operating state in which the distribution side controller monitors the distribution network to detect a trigger condition, wherein the trigger condition corresponds to a power imbalance in the distribution system; upon detecting a trigger condition, switching the distribution side controller to a recovery operating state in which the controller modifies the operation of one or more distribution side devices coupled to the distribution side devices to restore a power balance.

Some embodiments provide a distribution side controller for controlling one or more distribution side devices, including: a processor for controlling the operation of the distribution side controller; a power system interface for coupling the controller to a power system, wherein the processor is adapted to monitor the power system to detect trigger conditions; a distribution network device interface for coupling the processor to the distribution side devices, wherein the processor is configured to modify the operation of one or more distribution side devices to restore a power imbalance in response to a trigger condition.

In some embodiments, the power system interface includes a distribution network interface for coupling the controller to a distribution system, wherein the distribution side devices are coupled to the distribution network.

In some embodiments, the power system interface includes a transmission network interface for coupling the controller to a transmission network coupled between the distribution network and a power generation subsystem, wherein the controller is configured to monitor one or more characteristics of the transmission network.

In some embodiments, the power system interface includes a power generation subsystem interface for coupling the controller to a power generation subsystem, wherein the controller is configured to monitor one or more characteristics of the power generation subsystem.

In some embodiments, the distribution side controller includes an external data interface for receiving external data from an external devices and wherein the processor is configured to modify the operation of the distribution side devices in response to the external data.

In some embodiments, the controller has a steady operating state and a recovery operating state, wherein: in the steady operating state, the controller monitors the power system to detect a trigger condition; and in the recovery operating state, the controller modifies the operation of one or more distribution side devices in response to the trigger condition.

In some embodiments, the controller also has an optimization operating state, wherein, in the optimization operating state, the controller modifies the operation of distribution side devices to preferred operation mode.

In some embodiments, the preferred operation mode achieves an objective selected from the group consisting of: increasing usage of renewable energy sources: increasing feed-in power in the distribution network; increasing power production by cost effective power sources; increasing power production by energy efficient power sources; decreasing power consumption in the distribution network; and decreasing power consumption in a power network coupled to the distribution network.

Some embodiments provide a method of operating one or more distribution side controllers in a power system including a power generation subsystem and one or more distribution networks, wherein at least some of the distribution networks include one of the distribution side controllers and a plurality of distribution side devices coupled to the respective distribution network, the method including: identifying a trigger condition; and in response to the trigger condition, restoring a power balance by modifying the operation of one or more distribution side devices coupled to one of the distribution networks.

In some embodiments, the method includes identifying the trigger condition in a first distribution network and restoring the power balance by modifying the operation of distribution side devices in at least two distribution networks.

In some embodiments, the method includes coupling distribution side controllers of at least two distribution network together to allow communication between such distribution side controllers.

In some embodiments, the coupled distribution side controllers cooperate to restore the power balance in response to the trigger condition.

In some embodiments, the method includes coupling distribution side controllers of at least two distribution side controllers together as peer distribution side controllers.

In some embodiments, at least two peer distribution side controllers cooperate to restore the power balance by modifying the operation of one or more distribution side devices in at least one distribution network in response to a trigger condition identified in another distribution network.

In some embodiments, at least two peer distribution side controllers cooperate to restore the power balance by modifying the operation of distribution side devices in at least two distribution networks in response to the trigger condition.

In some embodiments, the method includes coupling distribution side controllers of at least two distribution side controllers together, wherein one of the coupled distribution side controllers acts as a master distribution side controller.

In some embodiments, the master distribution side controller manages coordination of other coupled distribution side controllers.

In some embodiments, the power system includes a power generation subsystem and an automatic gain controller for controlling power generation by the power generation subsystem and wherein at least one of the distribution side controllers is coupled to the automatic gain controller and wherein the method includes coordinating the operation of distribution side devices with the automatic gain controller.

In some embodiments, the method includes modifying the operation of distribution side devices to a preferred operation mode, wherein the preferred operation mode include operational objectives relating to at least two distribution networks.

Some embodiments provide a power system including: a power generation subsystem; and one or more distribution networks coupled to the power generation subsystem to receive power from the power generation subsystem, wherein at least one of the distribution networks includes: one or more distribution side devices; and distribution side controller coupled to the distribution side devices to control the operation of the distribution side devices in response to a trigger condition occurring in the power system.

In some embodiments, each distribution side controller is coupled to is coupled to the corresponding distribution network to detect a trigger condition in the distribution network.

In some embodiments, a transmission network is coupled between the power generation subsystem and at least one of the distribution networks.

In some embodiments, at least one of the distribution side controllers is coupled to the transmission network to detect a trigger condition in the transmission network.

In some embodiments, a data communication link coupling at least some of the distribution side controllers to one another to allow such distribution side controllers to exchange information.

In some embodiments, the coupled distribution controllers are configured to act as peers.

In some embodiments, one of the coupled distribution controllers is configured to act as a master distribution side controller that controls the operation of at least some of the other coupled distribution side controllers.

In some embodiments, the power system includes an automatic gain controller, wherein the distribution side controller is coupled to the automatic gain controller to receive data relating to changes in power generation in the power generation system.

### DESCRIPTION OF THE DRAWINGS

A preferred embodiment of the present invention will now be described in detail with reference to the drawings, in which.

FIG. 1 illustrates a first power system;

FIG. 2 illustrates a distribution side controller of the system of FIG. 1;

FIG. 3 illustrates a method for operating the distribution side controller;

FIG. 4 illustrates some power levels in a distribution network of the system of FIG. 1;

FIG. 5 illustrates a second power system;

FIG. 6 illustrates another power system; and

FIG. 7 illustrates some signals in the system of FIG. 6.

It will be understood that the drawings are exemplary only. All reference to the drawings is made for the purpose of illustration only and is not intended to limit the scope of the embodiments described herein below in any way. For convenience, reference numerals may also be repeated (with or without an offset) throughout the figures to indicate analogous components or features.

### DESCRIPTION OF EXEMPLARY EMBODIMENTS

It will be appreciated that numerous specific details are set forth in order to provide a thorough understanding of the exemplary embodiments described herein.

However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of some of the methods, systems and apparatus described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, a suitable programmable computers may be a server, network appliance, set-top box, embedded device, computer expansion module, personal computer, laptop, personal data assistant, mobile device or any other computing device capable of being configured to carry out the methods described herein. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. For example, a program may be written in XML, HTML 5, and so on. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the methods, systems and apparatus of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

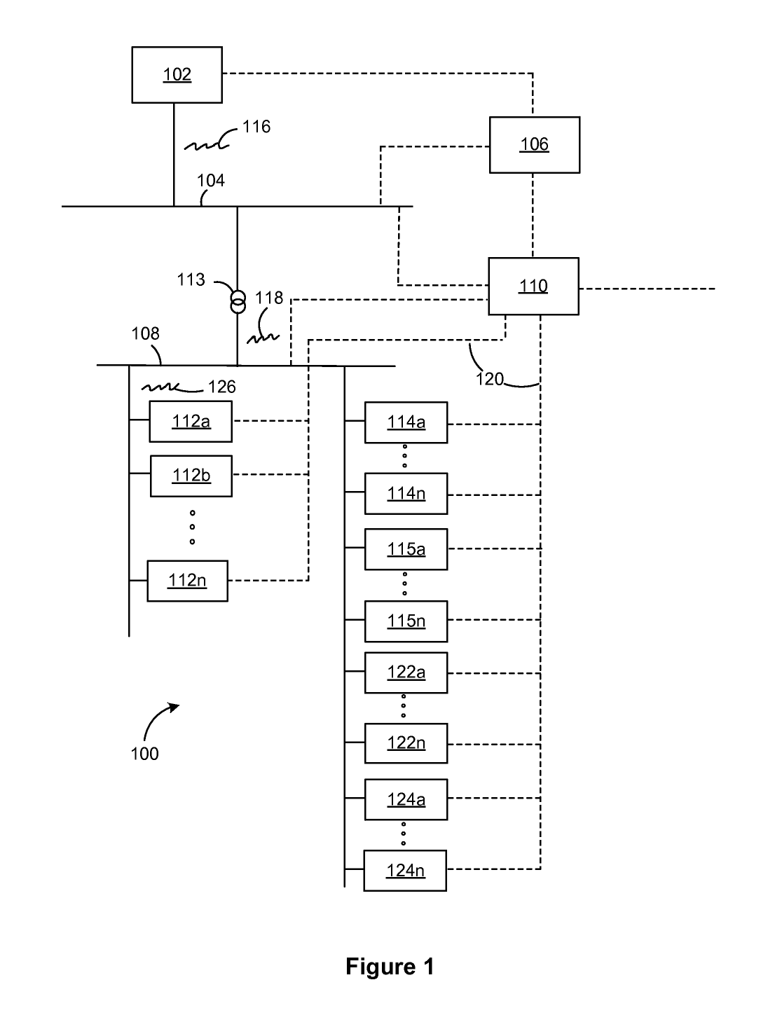

Reference is first made to FIG. 1, which illustrates a first power system 100. Power system 100 includes a power generation subsystem 102, a power transmission network 104, an automatic generation controller 106, a power distribution network 108, a distribution side controller 110, one or more distributed power sources 112 and one or more loads 114 and 115. System 100 also includes a data communication network 120 that allows devices in system 120 to communicate with one another. In various embodiments, a power system may include multiple data communication networks.

Power generation subsystem 102 may include one or more power sources including hydroelectric, nuclear, geothermal, biomass, gas-fired, coal and any other type of power plants and sources. Power generation subsystem 102 may also include power sources such as wind powered power sources (or “wind power sources”), solar or photovoltaic power sources, wave energy power sources or other renewable power sources. Power generation subsystem 102 provides a transmission power supply 116 to the remainder of system 100 through transmission network 104.

Transmission network 104 is typically, but not necessarily, coupled to distribution network 108 at a transformer or transformer station 113. Transformer station 113 provides a distribution power supply 118 by reducing the line voltage of the transmission power supply 116 supplied by the power generation subsystem 102 to a lower voltage for the distribution power supply 118 on distribution network 108.

Transmission network 104 is typically used in a power system that is geographically widely distributed and requires power to be transferred a substantial distance from various power generation sources to one or more distribution networks. The use of transformer stations 113 is optional and in some embodiments, the power generation subsystem 102 may directly generate a power supply suitable for use as a distribution power supply. In such systems, the transmission network 104 may be omitted and a distribution network 108 may couple power sources to other components in the system. In various systems, some power sources may be coupled to other components of the system through a transmission network and a transformer station while other power sources are coupled to other components of the system directly through a distribution network.

Distribution network or distribution feeder 108 provides distribution power supply 118 to one or more loads, including controllable loads 114 and non-controllable loads 115. Controllable loads 114 may be controlled to limit the power drawn by such loads from the distribution network 108. The controllable loads 114 may include loads that are continuously controllable (which can be instructed by the distribution side controller 110 to draw power at any level within a range), discrete-step controllable loads (which can be instructed by the distribution side controller to draw power at one of two or more specific levels) and on/off controllable loads (which can be instructed by distribution side controller to either draw power or to shut-off, thereby stopping any power draw).

Non-controllable loads 115 are not controllable by system 100 and typically draw power from the distribution network based on the use of such loads by their respective users.

In addition, distribution network 108 may be coupled to one or more distributed power sources 112, which may include any type of power sources, including wind power sources, solar power sources, other power sources that rely on renewable energy and any other type of power source. At least some of the distributed power sources 112 in the distribution network are operable to provide a feed-in power supply 126 that is injected into the distribution network and which may be used to power loads coupled to the distribution network.

Distribution network 108 may also be coupled to one or more energy storage units including system energy storage units 122 and multi-purpose storage units 124.

Primary energy storage units 122 are energy storage units that can receive power from the distribution network 108, store the received energy and subsequently inject the stored energy into the distribution network for consumption by a load coupled to the distribution network or for export to the transmission system 104. Primary energy storage units 122 are typically specific purpose units that are permanently coupled to the distribution network 108 for the purpose of storing energy drawn from the distribution network and returning energy to the power network.

Multi-purpose energy storage units 124 operate in a manner similar to primary energy storage units 122 to receive, store and inject stored power from and to the distribution network 108. In addition, multi-purpose energy storage units may be used for other purposes. For example, the battery of an electric vehicle or a hybrid electric vehicle may be a multi-purpose energy storage unit 124. While coupled to distribution network 108, the battery may be used to storage energy from and inject energy into the distribution network 108. In some embodiments, the operator of system 100, or a part of system 100 may enter into an agreement with the owner of a multi-purpose energy storage unit 124 to allow the operator to make use of the multi-purpose energy storage unit.

System 100 includes an automatic generation controller 106 which operates to control the generation of electric power by the power generation subsystem 102. An AGC module in a power system is typically operational to increase or decrease power production by various power sources in a power generation subsystem. An AGC is responsive to changes in availability of power from particular power sources and controls the production of power by dispatchable power sources such that one or more characteristics, such as system frequency, measured by the AGC remain within a selected range. This typically ensures an approximate balance between energy injected into the system by power sources (including energy storage units in a charging mode) and energy consumed by loads (including energy storage units in an injection mode), when averaged over a time period between tens of seconds to several minutes. In many cases, the balance between power supply and power consumption is managed by operating various power sources in a partially utilized conditions. Dispatchable power sources, such as thermal or hydroelectric power plants are operated above the power level required to meet power consumption. Excess power is discharged or otherwise dumped or consumed so that it is not injected into the power grid. The excess power supply is a spinning reserve that is available to be dispatched quickly in the event that power consumption rises, another power source fails or there is another requirement for a rapid increase in the amount of power required to be injected into the system. When required, the AGC can control a power source with a spinning reserve (or other devices coupled to the power source) to direct more power into the power grid. The balance between power supply and power consumption is maintained at the cost of generating and dumping excess power. It is desirable to reduce the amount of spinning reserve power.

In modern power systems, there is increasing penetration of renewable power sources, such as wind power sources and solar power sources which are not dispatchable or are at least subject to the availability of environmental factors such as wind or light. In some cases, such power sources may be dispatchable within a range of operation that is limited by the availability of such environmental factors. These power sources may be highly intermittent and power availability from them may be high unpredictable, particularly when weather or other relevant conditions change. Despite this, the natural energy sources that power these power sources are relatively inexpensive and for this and other reasons, it generally desirable to increase the penetration of renewable power sources in the provision of electric power.

The distribution side controller 110 is coupled to various devices on the distribution network 108 through a control and communication network 120 including some or all of the distributed power sources, the controllable loads 114 and the energy storage units 122 and 124. In some embodiments, the control and communications network 120 may be implemented using parts of the transmission and distribution networks. Distribution side controller 110 is able to individually address, obtain information from and control the operation of at least some of the distribution side devices to which it is coupled, including controllable loads 114, distributed power sources 112 and energy storage units 122 and 124.

Distribution side controller 110 is also coupled to AGC 106 to coordinate control of the power generation subsystem 102 with control of the distribution network devices to which the distribution side controller 110 is coupled.

In this embodiment, the distribution side controller 110 is responsive to changes in the balance of power input to and power consumption from distribution network 108. Distribution side controller 110 is responsive to distribution network imbalances over relatively short time periods ranging from fractions of a second to tens of seconds, allowing a local power balance to be maintained in the distribution network. This may reduce power imbalances in the transmission network 104 and thereby reduce the need for spinning reserves in the generation subsystem 102.

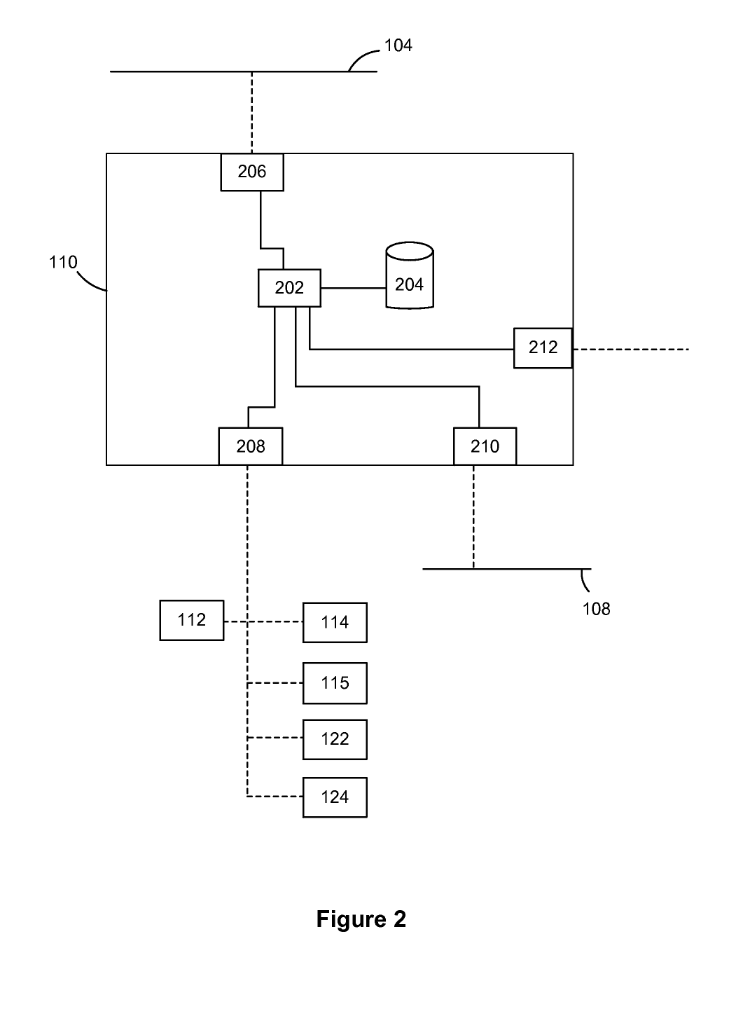

Reference is next made to FIG. 2, which illustrates distribution side controller 110. Distribution side controller 110 includes a processor or processing element 202, a data storage element 204, a transmission system interface 206, a power system interface which include a distribution network interface 208 or a transmission network interface 206 or both, a distribution network device interface 210 and an external data interface 212, which may communicate with external devices and data sources through an external data communication network 130, which may be part of communication network 120. Processor 202 and other elements of distribution side controller 110 may be configured to perform various methods to allow distribution side controller 110 to communicate with other elements of system 100 and to control the operation of various element of system 100.

Data storage element 204 is a non-transitory memory that may be used to record data. Data recorded in data storage element 204 is accessible to processor 202.

Transmission system interface 206 is coupled to power transmission network 104 and includes sensors that allow controller 110 to monitor one or more characteristics of the transmission network 104 and the transmission power supply 116.

Distribution system interface 208 is coupled to power distribution network 108 and includes sensors to monitor one or more characteristics of the distribution power network 108 and the distribution power supply 118.

Distribution network device interface 210 is coupled to communication network 120 to communicate with other device and components coupled to the communication network, which may be any type of public or private data communication network that allows coupled devices to transmit and receive data. Some or all of the distribution network devices, which include devices coupled to the power distribution network 108, including distributed power sources 112, energy storage units 122 and 124 and controllable loads 114 are also coupled to communication network 120. Processor 202 may be configured to transmit control signals and to receive data from at least some of the distribution side devices using distribution network device interface 210 and communication network 120.

Controller 110 may be configured (typically by appropriately configuring processor 202 and other components of controller 110, as generally described above), to communicate with and control distribution network devices in different ways depending on the nature and capabilities of the particular device. In system 100, distribution side controller 110 may control various distribution network devices as follows:

| Distribution | |
|---|---|
| Side Device | Control options |
| Controllable | Controller 110 may instruct a controllable load to reduce |
| load 114 | or stop drawing energy from the distribution network 108 |
| | for a fixed or indeterminate time. |
| Distributed | Controller 110 may instruct a distributed power source |
| power source | 112 to increase power generation, reduce power |
| 112 | generation or stop power generation, |
| Energy storage | Controller 110 may instruct an energy storage unit to |
| units 122 and | store energy drawn from the distribution network, to |
| 124 | inject energy into the distribution network or to remain |
| | charged at the level of energy (from fully discharged to |
| | fully charged) that it may have at any time. |

External data interface 212 is optional. External data interface 212 may be coupled to external data sources allowing controller 110 to obtain external information from external databases, sensors and potentially from or about other power systems. For example, power system 100 may be electrically coupled to other power systems, typically through respective transmission networks of each system, to allow electrical power to be transferred between the power systems. In some situations, the price at which such power is made available may vary periodically and controller 110 may receive such external power pricing information, allowing controller 110 to take such information into account while controlling distribution network devices. Other information that may be available to controller 110 through external data interface may include environmental prediction information that may be used to estimate the availability of power from renewable energy sources, load prediction information that may be used to estimate power requirements as predicted load on a distribution network changes, power demands of power systems that may wish to purchase power from the network operator of power system 100 (the operator of power generation subsystem 102 or transmission network 104), market signals, system operator commands, locally measured signals and information from distributed energy management systems.

In various embodiments and in various situations, controller 110 may be configured to operate distribution side elements coupled to distribution network 108 to achieve various outcomes. For example, controller 110 may be configured to maximize the use of renewable energy sources, to minimize the cost of power consumed by loads coupled to distribution network 108, to reduce the spinning reserve required in the power generation subsystem, to provide short term control or fast control in response to rapid changes in power production or demand on a distribution network, to optimize operating points or conditions, to respond to market signals and other objectives.

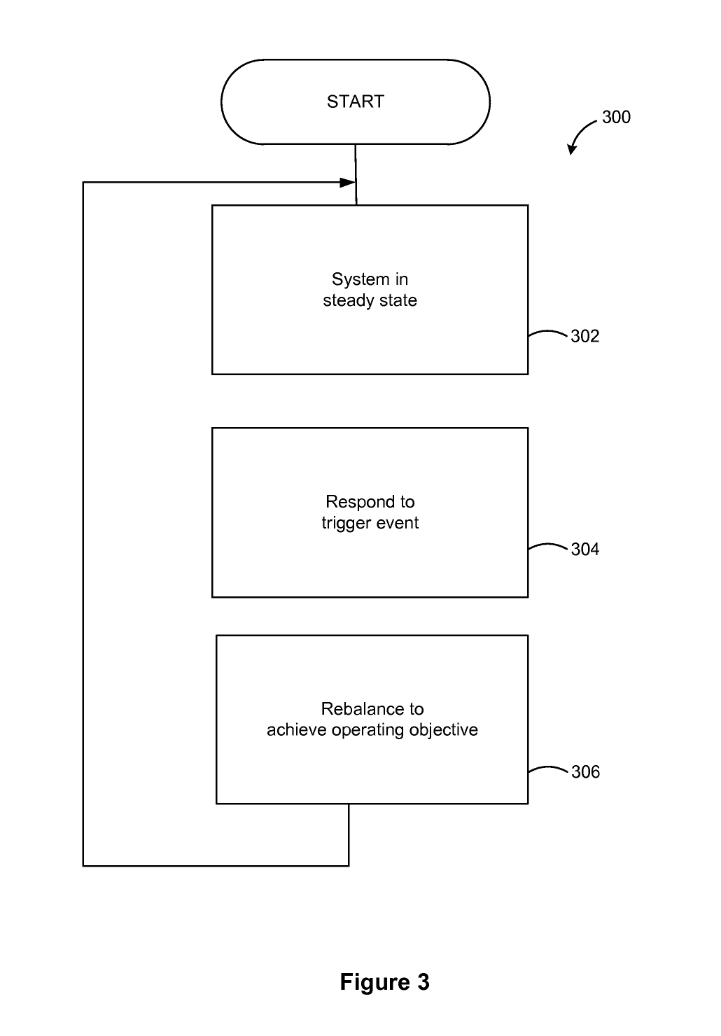

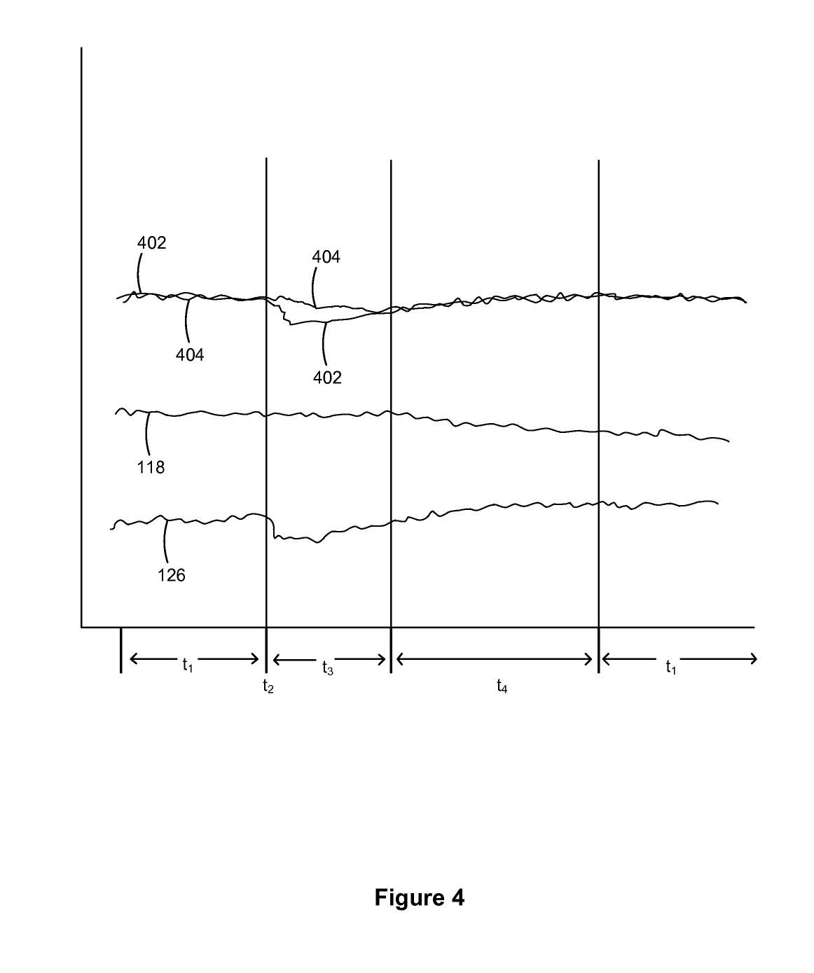

Reference is next made to FIGS. 3 and 4. FIG. 3 illustrates a method 300 for operating distribution side controller 110. FIG. 4 illustrates various power supply and demand levels in the distribution network 108. The time line in FIG. 4 is not to scale.

Method 300 begins in step 302 in which system 100 is operating in a steady state condition. The total distribution network power supply 402 in distribution network 108 at any point in time is a combination of the distribution power supply 118 and the teed-in power supply 126. In step 302, distribution side controller 110 is activated in a steady operating mode that corresponds to power system 100 being in a steady state normal operating condition. In steady state normal operation, the total distribution network load 404 drawn by all loads, including energy storage elements 122 and 124 that are storing power and power losses in the distribution network, in the distribution network is approximately equal to the total distribution network power 402. In this condition, as the total distribution network load 404 varies in a relatively slow and typically predictable manner, the AGC 106 controls power production by power generation subsystem 102 to match the variance and maintain a balance between total distribution network power 402 and total distribution network load 404. Time period t1 corresponds to step 302.

When the conditions monitored by distribution side controller 110 reach a state outside of a defined range, a trigger condition is deemed to have occurred, and controller 102 proceeds to step 302, in which the controller operates in a recovery operating state. The defined range will typically correspond to a desired balance condition in which system 100 is considered to be operating normally. The trigger condition may relate to a condition measured in distribution network 108 or in both the transmission and distribution networks.

For example, a trigger condition may relate to an imbalance between the distribution power supply 118 and the distribution system load drawn by all loads on distribution network 108 (including storage elements that are drawing power). For example, such a condition may result from a distributed renewable energy source unexpectedly providing reduced power, thereby reducing the feed-in power supply 126. Controller 110 may identify such a condition by monitoring the distribution power supply 118, the feed-in power supply 126 or controller 110 may receive information about the availability of feed-in power from a distributed power source through communication network 120.

The occurrence of a trigger condition may detected in various ways, depending on the specific distribution side characteristics and other information available to distribution side controller 110. For example, distribution side controller may monitor the line frequency on the distribution network 108. If the distribution network line frequency varies outside an acceptable range, then a trigger condition has occurred. In various electrical systems, the target line frequency is 60 Hz or 50 Hz. An acceptable operating frequency range may be 59.8 Hz-60.2 Hz or 49.8 Hz or 50.2 Hz. If the line frequency is outside this range, then the distribution network 108 is considered to be out of balance and a trigger condition has occurred. In other embodiments, the distribution side controller may be configured to control the line voltage in the distribution network, reactive power in the distribution network or a combination of frequency, voltage and/or reactive power control.

Referring to FIG. 4, at time t2, a trigger condition occurs and method 300 proceeds to step 304. In the illustrated example, total distribution network power 402 has begun to fall below the total distribution network load 404. Controller 110 detects this trigger condition and begins to respond to restore a balance between total distribution network power 402 and distribution network load 404 during time period t3.

In this example, the controller 110 begins to increase distribution power supply 118. Controller 110 may do so by dispatching greater power production from one of the distributed power sources 112 or from the energy storage units 122 or 124. Typically, distribution side controller 110 will dispatch power from a power source that can rapidly provide the required power and thereby restore the power balance in distribution network 108.

The specific response taken by controller 110 will depend on the trigger condition that occurred at time t2 and the ability of distribution network elements to respond to the resulting imbalance.

In the example, illustrated in FIG. 4, the total distribution network power supply 402 has fallen below total distribution network demand 404. The controller 110 may respond to this condition by increasing power input to the distribution network 108, by reducing load or a combination of both actions. In the illustrated example, the distribution side controller 110 takes both actions during time period t3 to achieve a new power balance in which the load demand has been reduced and additional feed-in power has been dispatched from distributed power sources or from storage elements or both.

The distribution side controller 110 may reduce power demand or load 404 in the distribution network 108 by instructing controllable loads 114 to reduce or altogether stop their power consumption. The specific actions to be taken may be determined by the distribution side controller 110 based on the availability of controllable elements in the distribution network and on the objectives configured into the distribution side controller.

In other situations, a load may suddenly reduce the power it is consuming, for example, if the load is rapidly shut down intentionally or due to an emergency situation arising. The resulting imbalance will be an excess of total distribution network power 402 exceeding the total distribution network load 404. The controller 110 may be configured to reduce power input to the distribution network 108 or to increase power drawn for the distribution network 108 or a combination of these action to restore a balance to the distribution network.

The distribution side controller 108 may reduce power input to the distribution network 108 by dispatching less power from operating distributed power sources 112a. The distribution side controller 108 may increase power demand on the distribution network by increasing power storage to storage elements 122 and 124 or by instructing a controllable load to increase power draw from the distribution network.

During step 304, the distribution side controller re-establishes a balance between total distribution network power supply 402 and total distribution network load 404. In some cases, this will be done by taking a combination of the actions described above.

Method 300 then proceeds to step 306, in which the distribution side controller 110 modifies the operation of distribution side devices to a preferred operation mode. This corresponds to time period t4 in FIG. 4. As described above, the distribution side controller 110 may be operated for various objectives, including an attempt to increase the usage or penetration of renewable energy sources, reduce the magnitude and length of any power imbalance on the distribution network 108, reduce overall power generation and consumption at the distribution network level or at the system level and other objectives. In some embodiments, more than one of these objectives may be desirable. In step 304, the distribution side controller will typically operate to quickly restore a power balance on the distribution network 108. By acting quickly, the distribution side controller 110 may reduce the need for spinning reserves in the generation subsystem 102 (FIG. 1) and may achieve other objectives. However, such rapid action may be inconsistent with other objectives. For example, increasing power consumption by a controllable load to compensate for a rapid reduction in power drawn by another load may result in an inefficient power balance in the distribution network. The power balance may result in more power being generated and consumed in the network, which is inefficient. Furthermore, the increase in power consumption by a controllable load or power storage by a storage element may be unsustainable. At some point, the controllable load may not be able to continue to draw power at the increased level, or the storage element may be fully charged and may not be able to receive any additional power.

In step 306, the distribution side controller 110 modifies the operation of distribution side devices to achieve a power balance that is more efficient than was achieved in step 304.

Distribution side controller 110 will typically achieve a more efficient power balance by taking actions that are effective over a longer time period than required for the rapid response in step 304.

In a situation in which the trigger condition related to total distribution side power supply exceeding total distribution network load, the distribution side controller 110 may have created an inefficient power balance by rapidly reducing the feed-in power supply 126 or increasing power demand from a controllable load or both. In many cases the reduced feed-in power supply may be supplied by a group of distributed power sources that are not an efficient combination for the amount of feed-in power required, or for the total distribution network power supply required for the actual load demand on the distribution network. The distribution side controller may (i) reduce feed-in power and excess power consumed by controllable loads beyond the power actually required for the operation of the controllable loads or (ii) change the combination and amount of power supplied by different distributed power sources 112 to provide the feed-in power or both. These steps may be taken sequentially or simultaneously, with the objective of dispatching an amount of feed-in power from distributed power sources 112 that results in the total distribution network power supply 402 being balanced with the total distribution network load 404 with no controllable loads or energy storage elements operating at an artificially high power demand level. In addition, the distribution side controller achieves an efficient balance between different distributed power sources that together provide the feed-in power. For the example, this efficient balance may be intended to ensure that some or all of the distributed power sources are operating with a desired level of excess power generation capacity compared to their maximum power generation, to reduce the cost of feed-in power or to achieve another objective.

Similarly, in a situation where the trigger condition related to total distribution network load exceeding total distribution side power, the distribution side controller may (i) increase feed-in power and instruct controllable loads whose power consumption was reduced in step 304 to return to their normal power consumption and (ii) change the combination and amount of power supplied by different distributed power sources to provide the feed-in power 126 or both. Again, these steps may be taken sequentially or simultaneously with the objective that the total distribution power supply is increased to achieve a power balance with the total distribution network load, with no loads at an artificially suppressed power demand level. The distribution side controller also attempts to achieve an efficient power generation balance between different distributed power sources, as described above.

In some instances, the power balance on generation network 108 and the balance between different distributed power sources 112 achieved in step 304 may be sufficient that step 306 is not performed. In other embodiments, step 306 may not be implemented at some times or at all times.

After step 306 (or step 304 in instances or embodiments in which step 306 is not performed), method 300 returns to step 302. In some embodiments, steps 304 and 306 may be integrated or performed together.

In some embodiments, the distribution side controller may operate in conjunction with other distribution side controllers or with the automatic generation controller 106 to achieve efficiencies beyond distribution network 108.

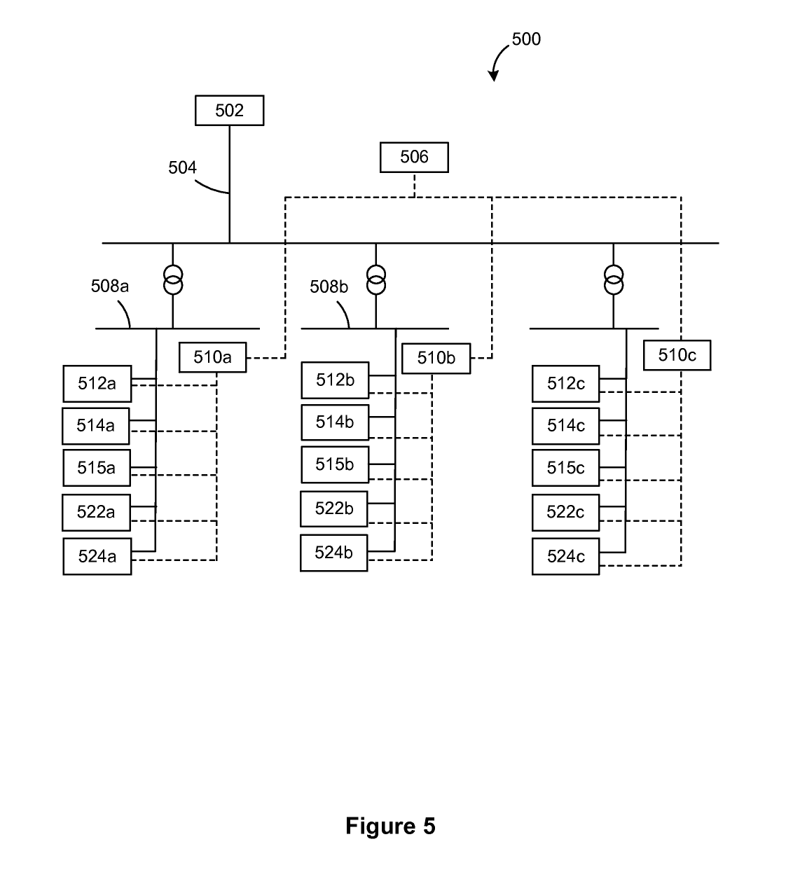

Reference is next made to FIG. 5, which illustrates another power system 500. Elements of system 500 that correspond to elements of system 100 are identified by similar or corresponding reference numerals. System 500 includes a power generation subsystem 500, a power transmission network 504 and a plurality of distribution networks 508. Each of the distribution networks includes a respective distribution side controller 510 and various distribution side devices 512, 514, 515, 522 and 524.

The distribution side controller 510 of each distribution network 508 operates as described above in relation to system 100 to identify imbalances in its respective distribution network, rapidly respond to such imbalances to restore a balance between total distribution network power supply and total distribution network load in that distribution network, and in some instances to rebalance the power supply and demand in the distribution network to achieve a more efficient or otherwise more desirable power balance.

In addition to the independent operation of each distribution side controller 510 to manage the power balance in it respective distribution network 508, some or all of the distribution side controllers may be coupled together through external data communication links. In some embodiments, the coupled distribution side controllers 510 may act as peers to share information and to allow power generation in system 500 to be managed more efficiently. For example, each distribution side controller 510 may be coupled to distributed power sources 512 within its respective distribution network 508 through communication network 520 to determine the maximum power that each distributed power source 512 can generate at any time. A distribution side controller 510 may indicate to its peer distribution side controllers that the distributed power sources 512 in its distribution network have reached their capacity or are operating at a level that is not efficient or is otherwise undesirable. One or more of the other peer distribution side controller 510 may determine that its distributed power sources could contribute additional power to system 500 efficiently to reduce the feed-in power requirements in first generation network. The peer distribution side controller may then coordinate a shift in power generation such that distributed power sources in one or more distribution networks may increase power production beyond that required for power their local distributed loads in their own distribution network. The excess power is used to supply other distribution networks through the transmission network 504.

In some embodiments, one of the distribution side controllers 510 may act as a master controller that manages coordination of the various distribution side controllers. The master distribution side controller may be programmed with information about the availability of different distributed power sources 512 in the various distribution networks 508. Other distribution side controller 508 may provide information about their respective available feed-in power and total distribution network load to the master distribution side controller. The master distribution side controller may then determine an efficient arrangement of feed-in power generation to supply the respective distribution network loads. This arrangement is then transmitted to each distribution side controller which then dispatches power from its various distributed power sources in accordance with the arrangement. In some instances, the distribution side controllers may vary from the arrangement to accommodate local objectives such as maintaining the availability of power from energy storage elements.

Referring still to FIG. 5, the distribution side controllers 510 are coupled through communication network 520 to AGC 506, either directly or indirectly. The distribution side controllers, or a master distribution side controller if one is designated, may communicate with the AGC to coordinate changes in power production in the power generation subsystem with changes in feed-in power from distributed power sources. For example, a master distribution side controller may report to the AGC 506 that excess capacity for feed-in power from renewable distributed power sources is available. The AGC and master distribution side controller may then coordinate an increase in feed-in power and a corresponding reduction in power generated in the power generation subsystem 502, allowing the total distributed network power supply in each distribution network to remain balanced with its respective total distribution network load, but in at least some of the distribution network, increasing to amount of feed-in power from renewable or other efficient or desirable power sources. In this way, the penetration of distributed power sources, and particularly efficient or renewable power sources, may be increased.

The distribution side controllers, or a master distribution side controller, may also be coupled to external data sources (not shown in FIG. 5) through communication network 520 or another communication network. The external data sources may provide information including environmental condition forecasts, demand forecasts for the system 500, individual distribution networks 508 or for other power systems that are interconnected with system 500. The distribution side controller may incorporate this information into its determination of an efficient power balance in step 306 of method 300 and similarly may incorporate such information into the coordination of power generation from distributed power sources 512 and from the power generation subsystem 502. By efficiently planning power generation for the system 500, the need for spinning reserves in the power generation subsystem 502 may be reduced.

In some embodiments, some or all of the distribution side elements may be at a particular facility or installation such as an industrial installation such as a factory or processing plant, a commercial facility such as an office building or a residential facility such as a large multiple residence building. The metal processing facility referred to below is an example of such an industrial installation or load.

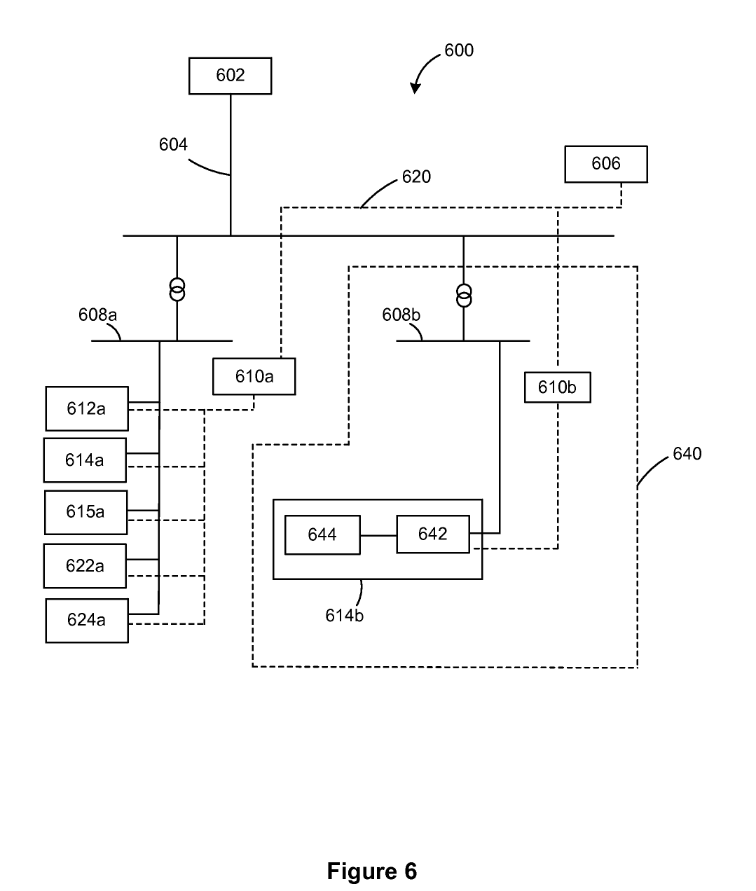

Reference is next made to FIG. 6, which illustrates another power system 600. Elements of system 600 corresponding to elements of systems 100 and 500 are identified by similar reference numerals. System 600 includes a power generation subsystem 602, a power transmission network 604 and a plurality of distribution networks 608. Distribution network 608b supplies power to a metal processing facility 640. Facility 640 includes one or more distribution side devices coupled to distribution network 608, including a controllable load 614a.

Controllable load 614b includes an industrial load, for example, an electric furnace 644 coupled to the distribution network through a power controller 642. Metal processing furnace 644 may be a smelting furnace, an electric arc furnace or another type of furnace. Some loads on a distribution network, such as some metal processing furnaces may be able to withstand wide variations in the power they draw from the distribution network, particularly for short time periods. Power controller 642 is coupled to distribution side controller 610b and is responsive to power control signals transmitted by the distribution side controller 610b through communication network 620. Distribution side controller transmits power control signals to the power controller 642 instructing the power controller 642 to draw a specified amount of power from the distribution network. The power controller 642 then makes all or some of this specified amount of power available to the industrial load 614b.

Distribution side controller 610b monitors the distribution network 608b to identify trigger conditions. In response to a trigger condition, the distribution side controller 610b may instruct the power controller 642 to draw a specified amount of power from the distribution network. The specified amount of power may result in a reduction in the power available to the industrial load 644. The distribution side controller is configured to control the power available to the industrial load 644 in accordance with the operational requirements and limitations of the industrial load 644. If the furnace can withstand a change in the power available to it for a limited time, then the distribution side controller 610b instructs the power controller 642 to vary the power available to the furnace for a period equal to or shorter than the limited time.

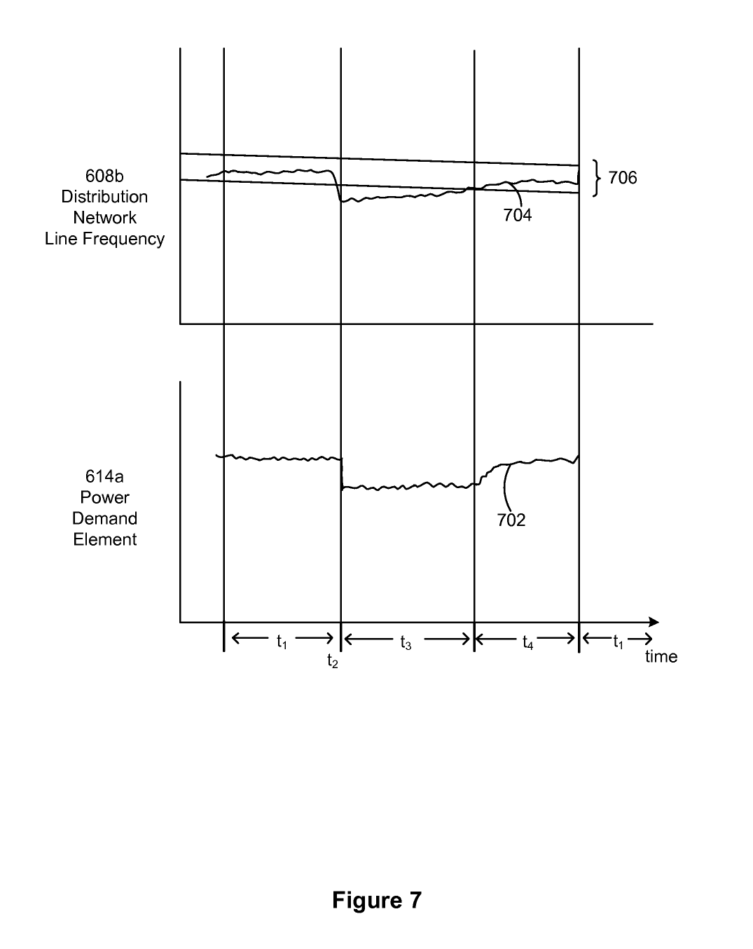

Reference is made to FIG. 7, which illustrates an example of the operation of system 600. System 600 operates in the manner described above in relation to method 300 (FIG. 3) and the time periods t1-t4 identified in FIG. 7 correspond generally to the corresponding time periods in FIG. 4. In FIG. 7, the power drawn by controllable load 614a is shown at 702. The distribution network line frequency is monitored by the distribution side controller 610b and is shown at 704.

System 600 is initially operating in a steady state condition during time period t1. At time t2, the distribution side controller 610b detects a trigger condition. In this example, the trigger condition is a sudden drop in the distribution network line frequency 704 below a target frequency range 706. The distribution network 608b is coupled to the transmission network 604. As a result, changes in conditions in a distribution network may arise due to events in other distribution networks, on the transmission network or in the generation subsystem 602. During time period t3, and in response to the trigger event at time t2, the distribution network controller 610 attempts to restore the distribution line network frequency. For example, the distribution side controller 610 may instruct the power controller 642 to draw less power from the distribution network than it is presently drawing. The distribution side controller 610 may do so by instructing the power controller 642 to reduce its power draw from the distribution network by a specified amount. The distribution side controller 610 may also do so by determining the power controller's current power draw when the trigger event occurs at time t2 from the distribution network and instructing the power controller to draw a specified amount of power that is less than the current power draw. This results in less power being available to the furnace 644.

During time period t3, the reduction in power drawn by the power controller from the distribution network results in the distribution line frequency 704 rising back into the target frequency range 706.

During time t4, the distribution side controller 610b attempts to rebalance the operation of distribution side devices in distribution network 608 to achieve a preferred operation condition. For example, it may be desirable to remove any limitation on power drawn by the power controller 642. If the cause of the trigger event at time t2 is no longer present or has diminished sufficiently, the distribution side controller 610 may simply instruct the power controller 642 to return to normal operation, thereby providing the furnace 644 with full power as needed. If the trigger condition remains in effect, the distribution side controller may operate in conjunction with other distribution side controllers or with the AGC 606 or both during time period t4.

The particular action taken by the distribution side controller 610 in response to a particular trigger condition may vary based on the operational condition of the system and the objectives programmed into the distribution side controller. In various embodiments and situations, the distribution side controller may operate various distribution side devices to restore one or more measured characteristics to a balance condition. For example, if the distribution line frequency increases, the distribution side controller may reduce power input to the distribution network for distribution side sources, increase power demand from a controllable load or take another action or a combination of actions to restore the distribution line frequency to a desired range.

In the embodiment illustrated in FIG. 6, the only distribution side device illustrated in distribution network 608b is controllable load 614a. In other embodiments, other distribution side devices, including power sources, storage elements and other devices may be present in combination with a controllable load such as a furnace or other industrial load that may be operated in a degraded condition in which it temporarily receives a reduced power supply. A distribution side controller in such embodiments would control the operation of such distribution side devices and may optionally operate in conjunction with other distribution side devices and an AGC as described above.

The present invention has been described here by way of example only. Various modification and variations may be made to these exemplary embodiments without departing from the spirit and scope of the invention.

1. A method of controlling one or more distribution side devices coupled to a distribution network, the method comprising:
identifying a trigger condition; and
in response to the trigger condition, restoring a power balance between distribution network power and distribution network load.

2. (canceled)

3. (canceled)

4. (canceled)

5. The method of claim 1 wherein the power balance is restored by dispatching greater feed-in power to the distribution network.

6. The method of claim 1 wherein the power balance is restored by dispatching greater power production from a distributed power source.

7. (canceled)

8. The method of claim 1 wherein the distribution side devices include one or more controllable loads and wherein the power balance is restored by controlling one or more controllable loads to decrease power draw from the distribution network.

9. (canceled)

10. The method of claim 1 wherein the power balance is restored by dispatching less feed-in power to the distribution network.

11. The method of claim 1 wherein the power balance is restored by dispatching less power production from a distributed power source.

12. (canceled)

13. The method of claim 1 wherein the distribution side devices include one or more controllable loads and wherein the power balance is restored by controlling one or more controllable loads to increase power draw from the distribution network.

14. (canceled)

15. (canceled)

16. The method of claim 1 wherein the trigger condition relates to a change in feed-in power supply to the distribution network.

17. (canceled)

18. The method of claim 1 wherein the trigger condition relates to a change in distribution power supply to the distribution network.

19. The method of claim 1 wherein the trigger condition is identified by monitoring one or more conditions in the distribution network.

20. The method of claim 1 wherein the distribution network is coupled to a transmission network and the trigger condition is identified by monitoring one or more conditions in the transmission network.

21. The method of claim 1 further including modifying the operation of distribution side devices to a preferred operation mode, wherein the preferred operation mode maintains a power balance between distribution network power and distribution network load.

22. (canceled)

23. The method of claim 21 wherein the preferred operation mode achieves a preferred operation objective selected from the group consisting of:
increasing usage of renewable energy sources;
increasing feed-in power in the distribution network;
increasing power production by cost effective power sources;
increasing power production by energy efficient power sources;
decreasing power consumption in the distribution network; and
decreasing power consumption in a power network coupled to the distribution network.

24. A method of operating a distribution side controller for a power network including a distribution network, wherein the distribution network includes a plurality of distribution side devices, the method comprising:
activating the distribution side controller in a steady operating state in which the distribution side controller monitors the power network to detect a trigger condition, wherein the trigger condition corresponds to a power imbalance in the power system; and
upon detecting a trigger condition, switching the distribution side controller to a recovery operating state in which the controller modifies the operation of one or more devices coupled to the power network to restore a power balance.

25. The method of claim 24 wherein the distribution side controller is coupled to the distribution network and wherein, in the steady operating state, the distribution side controller monitors the distribution network to detect the power imbalance within the distribution network.

26. The method of claim 24 further comprising, after restoring the power balance, returning to the steady operating state.

27. The method of claim 24 further comprising, after restoring the power balance, switching the distribution side controller to a preferred operation mode in which the distribution side controller modifies the operation of one or more devices coupled to the power system to achieve a preferred operation objective.

28. (canceled)

29. The method of claim 27 further comprising, after achieving the preferred operation objective, returning to the steady operating state.

30. The method of claim 27 wherein the preferred operation mode achieves a preferred operation objective selected from the group consisting of:
increasing usage of renewable energy sources;
increasing feed-in power in the distribution network;
increasing power production by cost effective power sources;
increasing power production by energy efficient power sources;
decreasing power consumption in the distribution network; and
decreasing power consumption in a power network coupled to the distribution network.

31. (canceled)

32. (canceled)

33. (canceled)

34. (canceled)

35. (canceled)

36. A distribution side controller for controlling one or more distribution side devices, comprising:
a processor for controlling the operation of the distribution side controller;
a power system interface for coupling the controller to a power system, wherein the processor is adapted to monitor the power system to detect trigger conditions;
a distribution network device interface for coupling the processor to the distribution side devices, wherein the processor is configured to modify the operation of one or more distribution side devices to restore a power imbalance in response to a trigger condition.

37. The distribution side controller of claim 36 wherein the power system interface includes a distribution network interface for coupling the controller to a distribution system, wherein the distribution side devices are coupled to the distribution network.

38. The distribution side controller of claim 36 wherein the power system interface includes a transmission network interface for coupling the controller to a transmission network coupled between the distribution network and a power generation subsystem, wherein the controller is configured to monitor one or more characteristics of the transmission network.

39. The distribution side controller of claim 36 wherein the power system interface includes a power generation subsystem interface for coupling the controller to a power generation subsystem, wherein the controller is configured to monitor one or more characteristics of the power generation subsystem.

40. The distribution side controller of claim 36 further comprising an external data interface for receiving external data from an external devices and wherein the processor is configured to modify the operation of the distribution side devices in response to the external data.

41. The distribution side controller of claim 36 wherein the controller has a steady operating state and a recovery operating state, wherein:
in the steady operating state, the controller monitors the power system to detect a trigger condition; and
in the recovery operating state, the controller modifies the operation of one or more distribution side devices in response to the trigger condition.

42. The distribution side controller of claim 41 wherein the controller also has an optimization operating state, wherein, in the optimization operating state, the controller modifies the operation of distribution side devices to preferred operation mode.

43. The distribution side controller of claim 42 wherein the preferred operation mode achieves an objective selected from the group consisting of:
increasing usage of renewable energy sources;
increasing feed-in power in the distribution network;
increasing power production by cost effective power sources;
increasing power production by energy efficient power sources;
decreasing power consumption in the distribution network; and
decreasing power consumption in a power network coupled to the distribution network.

44.-63. (canceled)
